(19) United States
(12) Patent Application Publication
(10) Pub. No.: US 2020/0249528 A1
(43) Pub. Date: Aug. 6, 2020

(54) AREA LIGHT SOURCE MODULE AND CONTROL METHOD THEREFOR, AND DISPLAY DEVICE

(71) Applicants: HEFEI XINSHENG OPTOELECTRONICS TECHNOLOGY CO., LTD., Anhui (CN); BOE TECHNOLOGY GROUP CO., LTD., Beijing (CN)

(72) Inventors: Jinfeng ZHANG, Beijing (CN); Fangfang WU, Beijing (CN); Hui DONG, Beijing (CN); Mookeun SHIN, Beijing (CN); Aixia SANG, Beijing (CN); Shuai HUANG, Beijing (CN); Zhen ZHANG, Beijing (CN)

(21) Appl. No.: 16/758,493

(22) PCT Filed: Dec. 29, 2018
(86) PCT No.: PCT/CN2018/125195

§ 371 Date: Apr. 23, 2020

(30) Foreign Application Priority Data
Jun. 28, 2018 (CN) 201810691091.6

(51) Int. Cl. G02F 1/13357; F21V 8/00; G02F 1/1335; G02F 1/163; G02F 1/167

(52) U.S. Cl. CPC G02F 1/133606; G02B 6/0081; G02F 1/133528; G02F 2001/133607; G02F 1/167; G02F 1/133524; G02F 1/163

(57) ABSTRACT

An area light source module and a control method thereof, and a display device are disclosed. The area light source module includes a light guide plate, a light source, and a light valve component, the light guide plate includes two main surfaces and a side surface between the two main surfaces, the side surface includes an incident side surface, the light source is opposite to the incident side surface, and the light valve component is between the light guide plate and the light source. The light valve component is configured to control a passing rate of light emitted from the light source into the light guide plate through the incident side surface.

This application claims priority of the Chinese Patent Application No. 201810691091.6, filed on Jun. 28, 2018. For all purposes, the entire disclosure of the aforementioned application is incorporated by reference as part of the disclosure of this application.

### TECHNICAL FIELD

Embodiments of the present disclosure relate to an area light source module and a control method thereof, and a display device.

### BACKGROUND

With the development of science and technology and the progress of society, electronic display products are more and more widely used in daily life, and accordingly, people's requirements for the performance of electronic display products are becoming higher and higher. The industry has proposed high-dynamic range (HDR) image technology, which enables images displayed on electronic display products to have a higher contrast and more vivid colors, thereby better reflecting the visual effects in the real environment.

### SUMMARY

At least an embodiment of the present disclosure provides an area light source module, and the area light source module includes a light guide plate, a light source, and a light valve component; and the light guide plate includes two main surfaces and a side surface between the two main surfaces, the side surface includes an incident side surface, the light source is opposite to the incident side surface, the light valve component is between the light guide plate and the light source, and the light valve component is configured to control a passing rate of light emitted from the light source into the light guide plate through the incident side surface.

For example, in the area light source module provided by at least an embodiment of the present disclosure, the light valve component includes a plurality of light valve units arranged side by side, and a light transmittance of each of the light valve units is adjustable.

For example, in the area light source module provided by at least an embodiment of the present disclosure, the plurality of light valve units are arranged in a row or in an array of a plurality of rows and a plurality of columns along the incident side surface.

For example, in the area light source module provided by at least an embodiment of the present disclosure, each of the light valve units includes an electronic ink light valve unit, the electronic ink light valve unit includes an electronic ink layer and a plurality of control electrodes; and the electronic ink layer includes charged light-shielding particles, and the plurality of control electrodes are configured to control distribution of the charged light-shielding particles in the electronic ink layer to adjust a light transmittance of the electronic ink light valve unit.

For example, in the area light source module provided by at least an embodiment of the present disclosure, the electronic ink layer includes a plurality of capsules side by side, the capsules are filled with electrophoretic liquids and the charged light-shielding particles, and the charged light-shielding particles are suspended in the electrophoretic liquids.

For example, in the area light source module provided by at least an embodiment of the present disclosure, the plurality of control electrodes include a first electrode and a second electrode which are opposite to each other, and a third electrode and a fourth electrode which are opposite to each other, the first electrode and the second electrode are respectively arranged on two main surfaces of the electronic ink layer along a direction from the light source to the light guide plate, and the third electrode and the fourth electrode are respectively arranged on two side surfaces of the electronic ink layer along a direction perpendicular to the direction from the light source to the light guide plate.

For example, in the area light source module provided by at least an embodiment of the present disclosure, each of the light valve units includes an electrochromic light valve unit, the electrochromic light valve unit includes an electrochromic layer and a control electrode, and the control electrode is configured to be applied with a voltage to adjust a light transmittance of the electrochromic layer.

For example, in the area light source module provided by at least an embodiment of the present disclosure, each of the light valve units includes a liquid crystal light valve unit, the liquid crystal light valve unit includes a liquid crystal layer and a control electrode, and the control electrode is configured to control orientation of liquid crystal molecules in the liquid crystal layer to adjust a light transmittance of the liquid crystal light valve unit.

For example, in the area light source module provided by at least an embodiment of the present disclosure, the liquid crystal light valve unit further includes two polarizers, the two polarizers are respectively on both sides of the liquid crystal layer along a direction from the light source to the light guide plate, and polarization directions of the two polarizers are perpendicular to each other.

For example, the area light source module provided by at least an embodiment of the present disclosure further includes a controller, and the controller is coupled to the light valve unit to control the light valve unit.

For example, in the area light source module provided by at least an embodiment of the present disclosure, the light source includes a strip-shaped light source, or the light source includes a plurality of light-emitting units arranged at intervals.

For example, in the area light source module provided by at least an embodiment of the present disclosure, the light guide plate includes a plurality of strip-shaped zones spliced with each other in parallel, and the incident side surface is formed by splicing end surfaces of the plurality of strip-shaped zones.

For example, in the area light source module provided by at least an embodiment of the present disclosure, each of the strip-shaped zones corresponds to at least one of the light valve units.

For example, in the area light source module provided by at least an embodiment of the present disclosure, the incident side surface includes a first incident side surface and a second incident side surface which are adjacent to each other, the light source includes a first light source and a second light source, and the light valve component includes a first light valve component and a second light valve component; and the first light source and the first light valve component are on the first incident side surface, and the second light source and the second light valve component are on the second incident side surface.

For example, in the area light source module provided by at least an embodiment of the present disclosure, the light guide plate includes a first sub light guide plate and a second sub light guide plate which are stacked with each other; and the first light source and the first light valve component correspond to the first sub light guide plate, and the second light source and the second light valve component correspond to the second sub light guide plate.

For example, in the area light source module provided by at least an embodiment of the present disclosure, an orthographic projection of the light source on the incident side surface coincides with an orthographic projection of the light valve component on the incident side surface, or the orthographic projection of the light source on the incident side surface is within the orthographic projection of the light valve component on the incident side surface.

For example, in the area light source module provided by at least an embodiment of the present disclosure, the light valve component is in direct contact with the incident side surface.

At least an embodiment of the present disclosure further provides a display device including the area light source module according to any one of the above embodiments.

At least an embodiment of the present disclosure further provides a control method of the area light source module according to any one of the above embodiments, and the control method includes: controlling the light valve component, so as to control the passing rate of the light emitted from the light source into the light guide plate through the incident side surface.

For example, in the control method provided by at least an embodiment of the present disclosure, the light valve component includes a plurality of light valve units arranged side by side, and the control method further includes: controlling light transmittances of at least two adjacent light valve units, so as to adjust an intensity of incident light on a region, corresponding to the at least two adjacent light valve units, of the incident side surface of the light guide plate.

In the area light source module and the control method thereof, and the display device provided by at least an embodiment of the present disclosure, the light valve component controls the passing rate of light emitted from the light source into the light guide plate, so as to adjust distribution of light in the light guide plate, so that distribution of light emitted by the area light source module can be adjusted, and the dynamic contrast of the area light source module can be improved.

### BRIEF DESCRIPTION OF THE DRAWINGS

In order to clearly illustrate the technical solution of the embodiments of the present disclosure, the drawings of the embodiments will be briefly described in the following. It is obvious that the described drawings in the following are only related to some embodiments of the present disclosure and thus are not limitative of the present disclosure.

FIG. 1 is a planar diagram of an area light source module provided by an embodiment of the present disclosure;

FIG. 2A is a cross-sectional diagram of a structure of the area light source module illustrated in FIG. 1;

FIG. 2B is a cross-sectional diagram of another structure of the area light source module illustrated in FIG. 1;

FIG. 3 is a schematic diagram of distribution of light on an incident side surface of a light guide plate in an area light source module provided by an embodiment of the present disclosure;

FIG. 4 is a schematic structural diagram of a light valve component in an area light source module provided by an embodiment of the present disclosure;

FIG. 5A is a schematic diagram of a partial structure of the light valve component illustrated in FIG. 4;

FIG. 5B is a schematic diagram of another partial structure of the light valve component illustrated in FIG. 4;

FIG. 6 is a schematic structural diagram of another light valve component of an area light source module provided by an embodiment of the present disclosure;

FIG. 7 is a schematic structural diagram of still another light valve component of an area light source module provided by an embodiment of the present disclosure;

FIG. 8 is a planar diagram of another area light source module provided by an embodiment of the present disclosure;

FIG. 9 is a planar diagram of still another area light source module provided by an embodiment of the present disclosure;

FIG. 10 is a schematic diagram of the working principle of the area light source module illustrated in FIG. 9;

FIG. 11 is a planar diagram of further still another area light source module provided by an embodiment of the present disclosure; and

FIG. 12 is a cross-sectional diagram of a display device provided by an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, “coupled”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

One implementation method of HDR image technology is to design the light source module in the electronic display product to allow the light source module to have different adjustable light-emitting regions, and brightness of each adjustable light-emitting region can be adjusted. For example, the light source module has a plurality of light-emitting regions and each light-emitting region can be switched between different gray levels. For example, in the case where the light source module is a direct type light source module, not only the design thickness of the direct type light source module is large, but also an optical film such as a diffuser plate needs to be provided, which further increases the design thickness of the light source module and is against to the lightness and thinness of the light source module and even the electronic display product. In addition, the direct type light source module requires a large number of light sources arranged side by side, which greatly increases the manufacturing cost of the light source module and even the electronic display product. Moreover, the excessive number of light sources not only wastes energy, but also causes poor heat dissipation of the light source module, thereby adversely affecting the performance of the light source module and even the electronic display product.

At least an embodiment of the present disclosure provides an area light source module and a control method thereof, and a display device. The area light source module includes a light guide plate, a light source, and a light valve component. The light guide plate includes two main surfaces and a side surface between the two main surfaces, the side surface includes an incident side surface, the light source is disposed opposite to the incident side surface, and the light valve component is located between the light guide plate and the light source. The light valve component is configured to control a passing rate of light emitted from the light source into the light guide plate through the incident side surface.

In the area light source module of the above embodiment, the light valve component controls the passing rate of the light emitted from the light source into the light guide plate, and can adjust distribution of light in the light guide plate, so that distribution of light emitted by the area light source module can be adjusted and the dynamic contrast of the area light source module is improved. Moreover, the light source is located on the side surface of the light guide plate, which may reduce the design thickness of the area light source module and facilitate light and thin design. In addition, compared with the linear light source module of a similar specification, the area light source module of the above embodiment has fewer light sources, which can reduce the cost of the area light source module and avoid poor heat dissipation of the area light source module.

Hereinafter, the area light source module and the control method thereof, and the display device according to at least an embodiment of the present disclosure are described with reference to the drawings.

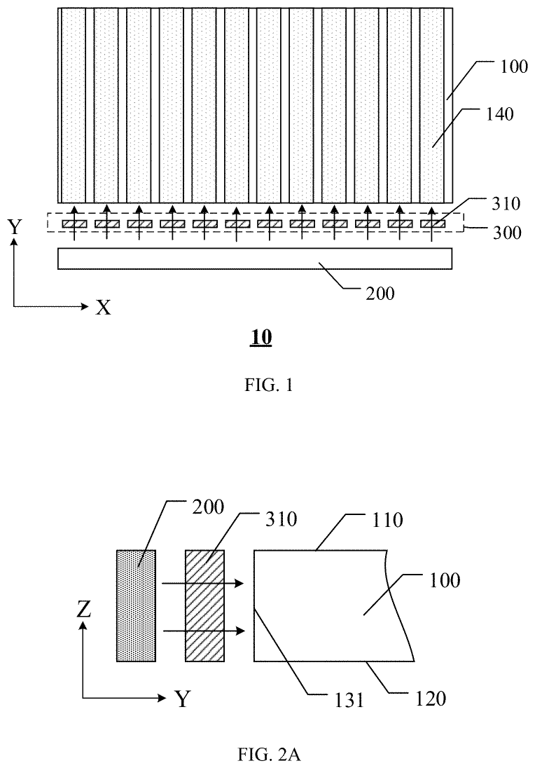

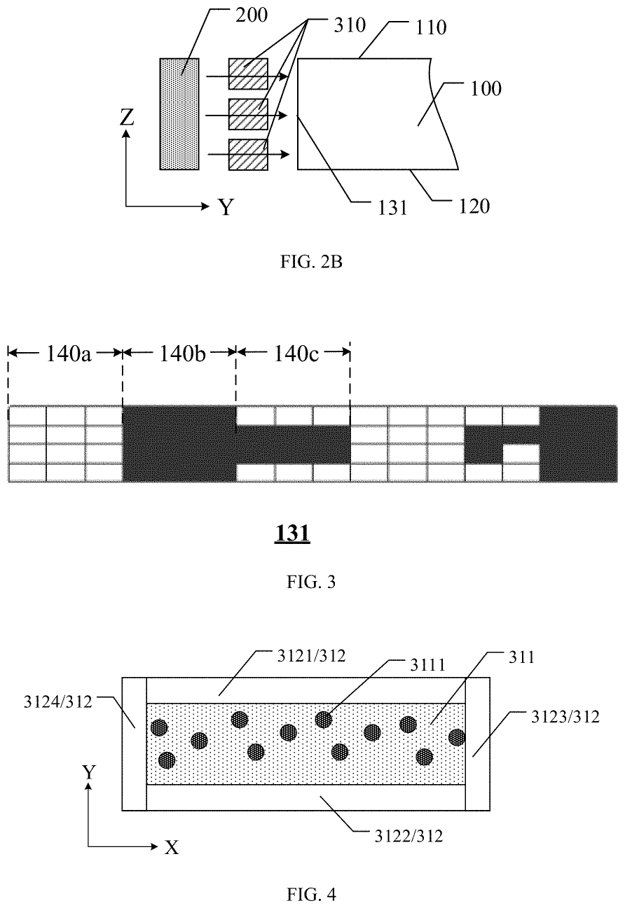

FIG. 1 is a planar diagram of an area light source module provided by an embodiment of the present disclosure, FIG. 2A is a cross-sectional diagram of a structure of the area light source module illustrated in FIG. 1, and FIG. 2 is a schematic diagram of a partial structure of the area light source module.

At least an embodiment of the present disclosure provides an area light source module. As illustrated in FIG. 1 and FIG. 2A, the area light source module 10 includes a light guide plate 100, a light source 200, and a light valve component 300. The light guide plate 100 includes two main surfaces and a side surface between the two main surfaces, the side surface includes an incident side surface 131, the light source 200 is disposed opposite to the incident side surface 131, and the light valve component 300 is located between the light guide plate 100 and the light source 200. The light valve component 300 is configured to control a passing rate of light emitted from the light source 200 into the light guide plate 100 through the incident side surface 131.

In the area light source module 10, the light valve component 300 is located between the incident side surface 131 and the light source 200, and can adjust the passing rate of the light emitted from the light source 200 and passing through the light valve component, so as to control distribution of light emitted from the light source 200 on the incident side surface 131, thereby controlling distribution of light in the light guide plate 100. In this way, the light intensity (brightness) distribution of the light emitted from the light-emitting surface 110 of the light guide plate 100 on the light-emitting surface 110 can be controlled, which improves the dynamic contrast of the area light source module and facilitates implementing the HDR image technology.

For example, as illustrated in FIG. 1 and FIG. 2A, the two main surfaces of the plate-shaped light guide plate 100 are a first main surface 110 and a second main surface 120, and the first main surface 110 is the light-emitting surface of the light guide plate 100, that is, the light emitted by the light source 200 and emitted out from the first main surface 110 (the light-emitting surface) is used, for example, to illuminate a display panel (for example, a liquid crystal display panel) to display an image.

For example, in at least an embodiment of the present disclosure, on one incident side surface of the light guide plate, an orthographic projection of the light source on the incident side surface coincides with an orthographic projection of the light valve component on the incident side surface, or the orthographic projection of the light source on the incident side surface is located within the orthographic projection of the light valve component on the incident side surface. In this way, the light valve component can adjust the passing rate of the light emitted from the light source into the light guide plate, thereby improving the effect of the area light source module on controlling the dynamic contrast.

In at least an embodiment of the present disclosure, a spatial rectangular coordinate system is established based on the plane (e.g., the first main surface) where the light guide plate is located to describe the structure in the area light source module. As illustrated in FIG. 1 and FIG. 2A, in the spatial rectangular coordinate system, the X axis and the Y axis are parallel to the plane where the light guide plate is located, and the Z axis is perpendicular to the plane where the light guide plate is located.

For example, in the area light source module provided by at least an embodiment of the present disclosure, the light valve component includes a plurality of light valve units side by side, and a light transmittance of each of the light valve units is adjustable. For example, as illustrated in FIG. 1 and FIG. 2A, in the area light source module 10, the light valve component 300 includes a plurality of light valve units 310 arranged side by side along the incident side surface 131 of the light guide plate 100, and the light transmittance of each light valve unit 310 can be adjusted by a controller (not shown, with reference to the controller 400 in FIG. 8). The light valve component 300 may be provided on the incident side surface 131 in a manner of bonding, snapping, etc., and for example, the light valve component 300 may be in direct contact with the incident side surface 131. In this way, by controlling the light transmittance of each light valve unit 310, the passing rate of light of the region, corresponding to the light valve unit 310, of the incident side surface 131 can be controlled, and the distribution of the light in the region, corresponding to the light valve unit 310, of the light guide plate 100 can be controlled, thereby controlling the gray level of the light-emitting region (for example, the zone 140 in FIG. 8) of the light guide plate 100 and improving the dynamic contrast of the area light source module.

In the area light source module provided by at least an embodiment of the present disclosure, the spatial arrangement of the light valve units is not limited. For example, in the area light source module provided by at least an embodiment of the present disclosure, the light valve units are arranged in a row or in an array of a plurality of rows and a plurality of columns along the incident side surface.

For example, in some embodiments of the present disclosure, the light valve units are arranged in a row along the incident side surface. For example, as illustrated in FIG. 1 and FIG. 2A, the plurality of light valve units 310 are arranged in one row along a direction (for example, the X axis direction) parallel to the incident side surface 131.

For example, in some other embodiments of the present disclosure, the light valve units are arranged in an array of a plurality of rows and a plurality of columns along the incident side surface. FIG. 2B is a cross-sectional diagram of another structure of the area light source module illustrated in FIG. 1, and FIG. 2B is a partial schematic diagram of the area light source module. As illustrated in FIG. 1 and FIG. 2B, the plurality of light valve units 310 are arranged in an array of a plurality of rows and a plurality of columns along a direction parallel to the incident side surface 131. For example, the plurality of light valve units 310 are arranged in a plurality of rows along the X axis direction, and the plurality of light valve units 310 are arranged in a plurality of columns along the Z axis direction. In this way, the control accuracy of the passing rate of the light emitted from the light source 200 into the light guide plate 100 can be further improved, thereby further improving the accuracy of the area light source module 10 in adjusting the dynamic contrast.

FIG. 3 is a schematic diagram of distribution of light on an incident side surface of a light guide plate in an area light source module provided by an embodiment of the present disclosure.

For example, as illustrated in FIG. 2B and FIG. 3, the incident side surface 131 of the light guide plate 100 includes a plurality of light-entering regions such as a region 140a, a region 140b, a region 140c, and the like. Each light-entering region corresponds to a plurality of light valve units 310 arranged in 4 rows and 3 columns. As illustrated in the figure, light transmittances of twelve light valve units 310 corresponding to the region 140a are adjusted to the maximum, light transmittances of twelve light valve units 310 corresponding to the region 140b are adjusted to the minimum (for example, not transmit light), light transmittances of six light valve units 310 corresponding to the region 140c are adjusted to the minimum (for example, not transmit light), and light transmittances of another six light valve units 310 corresponding to the region 140c are adjusted to the maximum. In this way, the passing rate of light of the region 140a is greater than the passing rate of light of the region 140b, and the passing rate of light of the region 140b is greater than the passing rate of light of the region 140c, so that on the light-emitting surface of the light guide plate, the gray level of the portion (e.g., the region 140 in the embodiments below) corresponding to the region 140a is greater than the gray level of the portion corresponding to the region 140b, and the gray level of the portion corresponding to the region 140b is greater than the gray level of the portion corresponding to the region 140c, thereby allowing different portions of the light-emitting surface of the light guide plate to provide different brightness. Therefore, by selecting and controlling the light transmittance of each light valve unit of the light valve unit array in the light-entering region, different combinations of positions and transmittances are obtained, thereby implementing different passing rates of light and improving the dynamic contrast of the area light source module.

In at least an embodiment of the present disclosure, the structure of the light valve unit is not limited as long as the light valve unit can be switched between different light transmittances. For example, the light valve unit has a transparent state and a light-shielding state. For example, in some embodiments of the present disclosure, in the transparent state, the light valve unit allows light to pass through and the light transmittance does not change; and in the light-shielding state, the light valve unit cannot allow light to pass through, or allows little light to pass through. For example, in some other embodiments of the present disclosure, in the transparent state, the light valve unit is configured to allow light to pass through and can be switched between a plurality of light transmittances; and in the light-shielding state, the light valve unit cannot allow light to pass through, or allows little light to pass through.

FIG. 4 is a schematic structural diagram of a light valve component in an area light source module provided by an embodiment of the present disclosure.

For example, in the area light source module provided by at least an embodiment of the present disclosure, the light valve unit includes an electronic ink light valve unit. Each electronic ink light valve unit includes an electronic ink layer and a plurality of control electrodes, the electronic ink layer includes charged light-shielding particles, and the plurality of control electrodes are configured to control distribution of the charged light-shielding particles in the electronic ink layer to adjust the light transmittance of the electronic ink light valve unit.

For example, as illustrated in FIG. 4, the light valve unit 310 includes an electronic ink layer 311 and a plurality of control electrodes 312, and charged light-shielding particles 3111 are provided in the electronic ink layer 311. After voltages are applied to the control electrodes 312, the electric field generated by the control electrodes 312 can allow the charged light-shielding particles 3111 to move in the electronic ink layer 311, thereby adjusting the distribution of the charged light-shielding particles 3111 in the electronic ink layer 311 to control the light transmittance of the light valve unit 310.

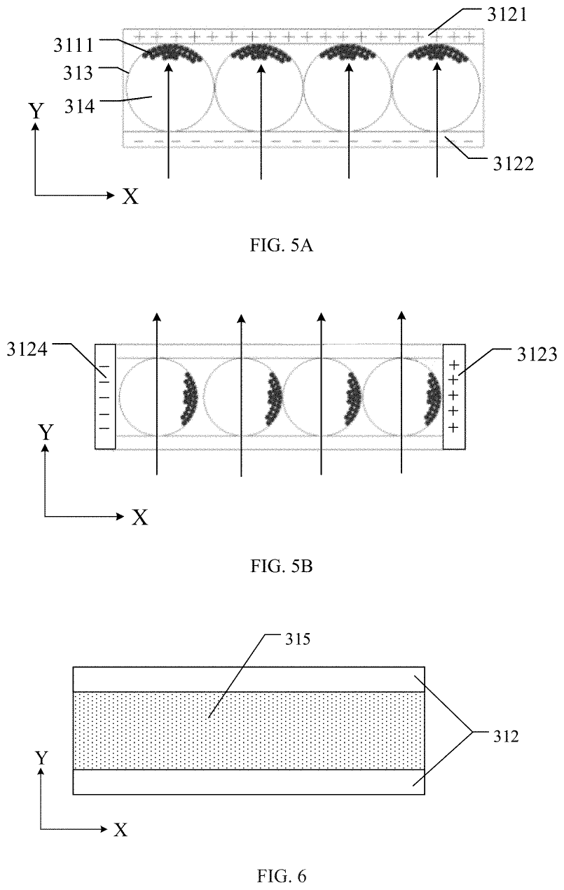

FIG. 5A is a schematic diagram of a partial structure of an example of the light valve component illustrated in FIG. 4, and FIG. 5B is a schematic diagram of another partial structure of the light valve component illustrated in FIG. 4.

For example, in the area light source module provided by at least an embodiment of the present disclosure, the electronic ink layer includes a plurality of capsules side by side, the capsules are filled with electrophoretic liquids and charged light-shielding particles, and the charged light-shielding particles are suspended in the electrophoretic liquids. For example, as illustrated in FIG. 4, FIG. 5A, and FIG. 5B, the electronic ink layer 311 includes a plurality of capsules 313 side by side, the capsules 313 are filled with electrophoretic liquids 314 and charged light-shielding particles 3111, and the charged light-shielding particles 3111 are suspended in the electrophoretic liquid 314. By providing the plurality of capsules 313 side by side, in the process of switching the light transmittance of the light valve unit, the moving distance of the charged light-shielding particles 3111 can be reduced, thereby reducing the response time of the light valve unit, avoiding the partial aggregation of the charged light-shielding particles 3111, facilitating the uniform distribution of the charged light-shielding particles 3111 in the electronic ink layer 311, and improving the accuracy of the light valve unit in adjusting the light transmittance.

In at least an embodiment of the present disclosure, the arrangement of the control electrodes in the electronic ink light valve unit is not limited as long as the control electrodes can allow the electronic ink light valve unit to be switched between different light transmittances.

For example, in the area light source module provided by at least an embodiment of the present disclosure, the plurality of control electrodes include a first electrode and a second electrode which are disposed opposite, and a third electrode and a fourth electrode which are disposed opposite, the first electrode and the second electrode are respectively arranged on two main surfaces of the electronic ink layer along a direction from the light source to the light guide plate, and the third electrode and the fourth electrode are respectively arranged on two side surfaces of the electronic ink layer along a direction perpendicular to the direction from the light source to the light guide plate. For example, as illustrated in FIG. 4, FIG. 5A and FIG. 5B, the plurality of control electrodes 312 include a first electrode 3121 and a second electrode 3122 which are disposed opposite, and a third electrode 3123 and a fourth electrode 3124 which are disposed opposite, the first electrode 3121 and the second electrode 3122 are located on two main surfaces (for example, parallel to the incident side surface of the light guide plate) of the electronic ink layer 311, and the third electrode 3123 and the fourth electrode 3124 are located on two side surfaces (for example, perpendicular to the incident side surface of the light guide plate) of the electronic ink layer 311. In this way, by controlling voltages on the first electrode 3121, the second electrode 3122, the third electrode 3123, and the fourth electrode 3124, the charged light-shielding particles 3111 may aggregate towards the main surface (for example, parallel to the incident side surface of the light guide plate) of the electronic ink layer 311, so that the light transmittance of the electronic ink light valve unit is reduced (for example, the light valve unit is in a light-shielding state); or the charged light-shielding particles 3111 may aggregate towards the side surface (for example, perpendicular to the incident side surface of the light guide plate) of the electronic ink layer 311, so that the light transmittance of the electronic ink light valve unit is increased (for example, the light valve unit is in a transparent state).

For example, as illustrated in FIG. 5A and FIG. 5B, in the electronic ink light valve unit, the charged light-shielding particles 3111 have negative charges. As illustrated in FIG. 5A, a positive voltage is applied to the first electrode 3121 and a negative voltage is applied to the second electrode 3122, so as to form an electric field directed from the first electrode 3121 to the second electrode 3122, so that the light-shielding particles 3111 with negative charges aggregate on a side, close to the first electrode 3121, of the capsule 313, the light emitted by the light source cannot pass through the electronic ink light valve unit, and the electronic ink light valve unit has a light-shielding state. As illustrated in FIG. 5B, a positive voltage is applied to the third electrode 3123 and a negative voltage is applied to the fourth electrode 3124, so as to form an electric field directed from the third electrode 3123 to the fourth electrode 3124, so that the light-shielding particles 3111 with negative charges aggregate on a side, close to the third electrode 3123, of the capsule 313, the light emitted by the light source passes through the electronic ink light valve unit, and the electronic ink light valve unit has a transparent state.

It should be noted that the charged light-shielding particles in the electronic ink light valve unit may also have positive charges, and during the working process, corresponding voltages are applied to the first electrode, the second electrode, the third electrode, and the fourth electrode according to practical requirements. Details are not described herein.

FIG. 6 is a schematic structural diagram of another light valve component of an area light source module provided by an embodiment of the present disclosure.

For example, in the area light source module provided by at least an embodiment of the present disclosure, the light valve unit includes an electrochromic light valve unit, the electrochromic light valve unit includes an electrochromic layer and a control electrode, and the control electrode is configured to be applied with a voltage to adjust the light transmittance of the electrochromic layer. For example, as illustrated in FIG. 6, the electrochromic light valve unit includes two control electrodes 312, and the electrochromic layer 315 is located between the two control electrodes 312. The voltages applied to the two control electrodes 312 are controlled to allow the electrochromic layer 315 to be switched between different light transmittances, so that the electrochromic light valve unit can have different light transmittances.

In at least an embodiment of the present disclosure, the type of electrochromic material in the electrochromic layer is not limited. For example, the electrochromic material may include tungsten trioxide, polythiophenes and derivatives thereof, violet alkaloids, tetrathiafulvalene, metal phthalocyanine compounds, or the like.

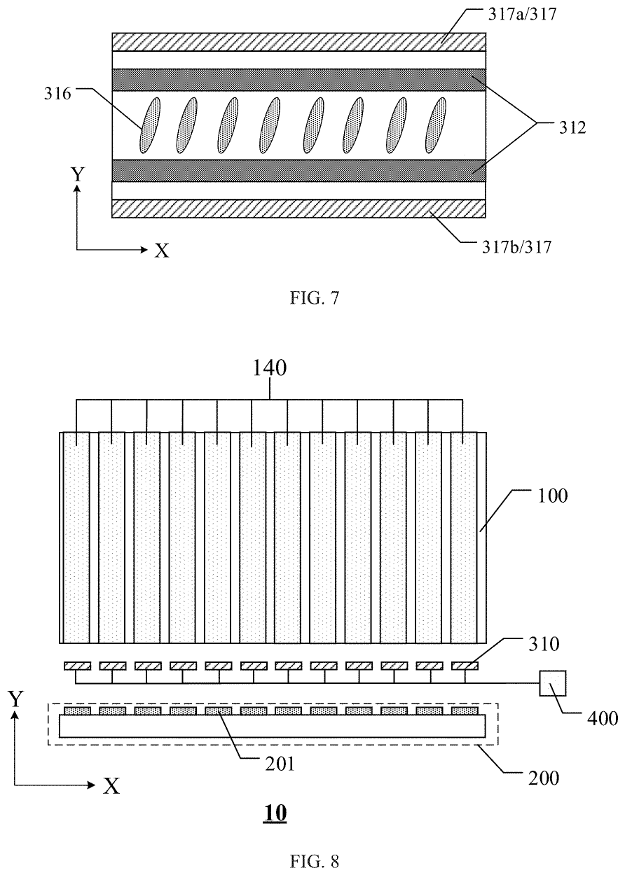

FIG. 7 is a schematic structural diagram of still another light valve component of an area light source module provided by an embodiment of the present disclosure.

For example, in the area light source module provided by at least an embodiment of the present disclosure, each light valve unit includes a liquid crystal light valve unit, the liquid crystal light valve unit includes a liquid crystal layer and a control electrode, and the control electrode is configured to control orientation of liquid crystal molecules in the liquid crystal layer to adjust the light transmittance of the liquid crystal light valve unit. For example, as illustrated in FIG. 7, the liquid crystal light valve unit includes a liquid crystal layer 316 and a control electrode 312. After a voltage is applied to the control electrode 312, the orientation of the liquid crystal molecules in the liquid crystal layer 316 can be controlled, thereby adjusting the light transmittance and further controlling the light transmittance of the liquid crystal light valve unit.

In at least an embodiment of the present disclosure, the number and positions of control electrodes in the liquid crystal light valve unit are not limited. For example, two control electrodes may be provided. For example, the two control electrodes are located on the same side of the liquid crystal layer, and for example, the two control electrodes are located between the liquid crystal layer and the light source, or between the liquid crystal layer and the light guide plate. For example, the two control electrodes are located on opposite sides of the liquid crystal layer, and for example, the two control electrodes are located between the liquid crystal layer and the light guide plate, and between the liquid crystal layer and the light source, respectively.

For example, in the area light source module provided by at least an embodiment of the present disclosure, the liquid crystal light valve unit further includes two polarizers, the two polarizers are respectively located on both sides of the liquid crystal layer along the direction from the light source to the light guide plate, and polarization directions of the two polarizers are perpendicular to each other. For example, as illustrated in FIG. 7, the liquid crystal light valve unit further includes two polarizers 317, a first polarizer 317a and a second polarizer 317b, and polarization directions of the two polarizers 317 are perpendicular to each other. In the Y axis direction, the first polarizer 317a and the second polarizer 317b are located on both sides of the liquid crystal layer 316, respectively.

The light emitted by the light source becomes linearly polarized light after passing through the second polarizer 317b, and the polarization direction of the linearly polarized light can be changed by controlling the orientation of the liquid crystal molecules in the liquid crystal layer 316 through the control electrode 312, thereby controlling the passing rate of the linearly polarized light through the first polarizer 317a.

More specifically, in the case where no voltage is applied to the control electrode 312, the light emitted from the light source and passing through the second polarizer 317b becomes linearly polarized light, the polarization direction of the light is unchanged after the light passes through the liquid crystal layer 316, the light cannot pass through the first polarizer 317a, and the liquid crystal light valve unit is in a light-shielding state. For example, the control electrode 312 is applied with a voltage and allows the liquid crystal molecules in the liquid crystal layer 316 to deflect by, for example, 90 degrees, and the light emitted by the light source and passing through the second polarizer 317b becomes linearly polarized light. But the polarization direction of the light deflects by 90 degrees after the light passes through the liquid crystal layer 316, the light can totally pass through the first polarizer 317a, the liquid crystal light valve unit is in a transparent state, and the light transmittance of the liquid crystal light valve unit is the maximum. Therefore, by adjusting the voltage applied to the control electrode, the orientation degree of the liquid crystal molecules can be changed, so that the liquid crystal light valve unit can be switched between a plurality of light transmittances in the transparent state.

It should be noted that, in at least an embodiment of the present disclosure, the relationship between the polarization direction of the first polarizer and the polarization direction of the second polarizer is not limited. For example, the polarization directions of the first polarizer and the second polarizer may also be set to be parallel to each other or at any angle, as long as the orientation of the liquid crystal molecules in the liquid crystal layer can be controlled to allow the liquid crystal light valve unit to have different light transmittances.

In at least an embodiment of the present disclosure, the material of the control electrode is not limited. For example, the control electrode may be a transparent electrode or a semi-transparent electrode. For example, the material of the control electrode may include indium tin oxide (ITO), indium zinc oxide (IZO), indium gallium oxide (IGO), gallium zinc oxide (GZO), zinc oxide (ZnO), indium oxide (In₂O₃), aluminum zinc oxide (AZO), carbon nanotubes, etc.

FIG. 8 is a planar diagram of another area light source module provided by an embodiment of the present disclosure.

For example, in at least an embodiment of the present disclosure, the area light source module further includes a controller, and the controller is coupled to the light valve unit to control the light valve unit. For example, as illustrated in FIG. 8, the controller is in signal connection with the control electrode in the light valve unit, thereby controlling the light transmittance of the light valve unit.

In at least an embodiment of the present disclosure, the type of the controller is not limited. For example, the controller may include a central processing unit (CPU), a programmable logic controller (PLC), etc., and may implement the power supply and signal input and output functions through additionally provided wires, signal lines, or the like.

In at least an embodiment of the present disclosure, the structure of the light source is not limited as long as the light source can emit light to the light guide plate. For example, in some embodiments of the present disclosure, the light source is an integrated strip-shaped light source. For example, in some other embodiments of the present disclosure, the light source includes a plurality of light-emitting units arranged at intervals. For example, the light-emitting units may be arranged in a row or in an array of a plurality of rows and a plurality of columns along the incident side surface.

For example, in the area light source module provided by at least an embodiment of the present disclosure, as illustrated in FIG. 8, the light source 200 includes a plurality of light-emitting units 201 arranged at intervals. For example, the light-emitting unit 201 corresponds to at least one light valve unit 310 in the light valve component. In this way, by controlling the light transmittance of the light valve unit 310, the amount of light emitted from each light-emitting unit into the light guide plate can be controlled, thereby improving the accuracy of the area light source module in adjusting the dynamic contrast. For example, in the area light source module provided by at least an embodiment of the present disclosure, the brightness of the light emitted by the light-emitting unit in the light source can be controlled separately. For example, the controller for the light source is coupled to the light-emitting unit to control the light-emitting brightness of each light-emitting unit. In this way, in conjunction with the light valve unit 310, the level of the passing rate of the light emitted from the light-emitting unit into the light guide plate can be further improved, and the dynamic contrast of the area light source module can be further improved.

In at least an embodiment of the present disclosure, the type of the light source is not limited. For example, the light source may be an electroluminescence (EL) device, a cold cathode fluorescent lamp (CCFL), a light-emitting diode (LED) device, etc., and for example, the light source may be formed in a structure such as a light bar. In some embodiments, an additional structure such as a reflective cover may be provided for the light source, so that the light-emitting surface of the light source can be controlled, and the light emitted by the light source can be more fully utilized.

In the following, the case where the light source includes a plurality of light-emitting units arranged at intervals is taken as an example to describe the technical solutions in at least an embodiment of the present disclosure described below.

For example, in the area light source module provided by at least an embodiment of the present disclosure, the light guide plate includes a plurality of strip-shaped zones spliced with each other in parallel, and the incident side surface is formed by splicing end surfaces of the plurality of strip-shaped zones. For example, as illustrated in FIG. 8, the light guide plate 100 includes a plurality of zones 140 spliced with each other in parallel, and the incident side surface (not shown in the figure, with reference to the incident side surface 131 in FIG. 2A) is formed by splicing end surfaces of the plurality of zones 140. For example, the zone 140 is in a strip shape. For example, the end surface of the zone 140 may be with reference to the region 140a, the region 140b, the region 140c and the like illustrated in FIG. 3. For example, the surfaces where adjacent zones 140 are spliced and in contact with each other may be formed as a reflective surface on the second main surface, and may be formed as a light-emitting surface on the first main surface.

For example, in at least an embodiment of the present disclosure, each zone corresponds to at least one light-emitting unit. For example, the zones and the light-emitting units are in one-to-one correspondence. It should be noted that in the case where the light guide plate 100 is in an integrated structure, the above-mentioned zones 140 are artificially divided regions, and the boundary of each zone may be defined by the distribution of the light emitted by the corresponding light-emitting unit in the light guide plate. For example, as illustrated in FIG. 8, in the case where the light valve unit allows light to pass through, the light emitted by the light-emitting unit 201 enters the corresponding zone 140 and may be emitted out from the surface, located in the light-emitting surface (the first main surface of the light guide plate), of the corresponding zone 140.

For example, in the area light source module provided by at least an embodiment of the present disclosure, each strip-shaped zone corresponds to at least one light valve unit. For example, each strip-shaped zone corresponds to a plurality of light valve units, and the amount (brightness) of light in each strip-shaped zone is adjusted by the plurality of light valve units, so that the control accuracy of the passing rate of the light emitted from the light source into the light guide plate can be further improved, thereby further improving the level of the passing rate of the light emitted from the light-emitting unit into the light guide plate and improving the dynamic contrast of the area light source module. For example, the setting relationship of the strip-shaped zone and the light valve unit may be with reference to related contents in the embodiments illustrated in FIG. 2B and FIG. 3, where the region 140a, the region 140b, and the region 140c correspond to one strip-shaped zone, respectively.

For example, in at least an embodiment of the present disclosure, the light valve unit may also be provided in an interval region of the strip-shaped zones, and during operation, the light valve unit corresponding to the interval region of the strip-shaped zones is adjusted to have a light-shielding state. In this way, the large-angle light emitted by the light-emitting unit can be shielded, the collimation degree of the light emitted from the light-emitting unit into the light guide plate can be improved, and the crosstalk of the light between strip-shaped zones can be reduced.

In at least an embodiment of the present disclosure, the number of light sources and light valve components in the area light source module is not limited. For example, in some embodiments of the present disclosure, one light source and one light valve component may be provided in the area light source module. The structure of the area light source module may be with reference to the related contents in the above embodiments, and details are not described herein. For example, in some other embodiments of the present disclosure, a plurality of light sources and a plurality of light valve components may be provided in the area light source module. In this way, the number of zones (e.g., strip-shaped zones) in the light guide plate can be increased, so as to improve the accuracy of the dynamic contrast of the area light source module.

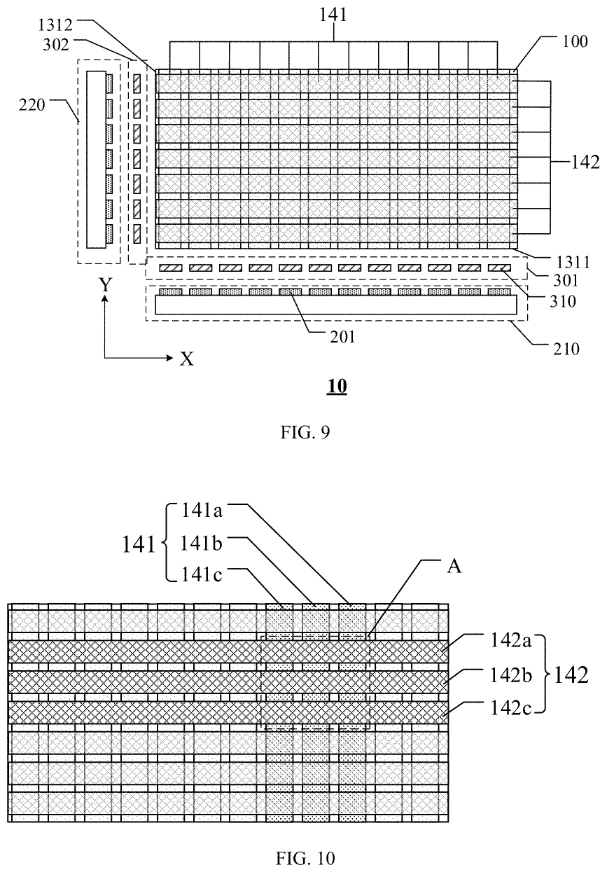

FIG. 9 is a planar diagram of still another area light source module provided by an embodiment of the present disclosure.

For example, in the area light source module provided by at least an embodiment of the present disclosure, the incident side surface is not limited to one side surface, and for example, the incident side surface includes a first incident side surface and a second incident side surface which are adjacent to each other. Accordingly, the light source includes a first light source and a second light source, the light valve component includes a first light valve component and a second light valve component, the first light source and the first light valve component are disposed on the first incident side surface, and the second light source and the second light valve component are disposed on the second incident side surface. For example, as illustrated in FIG. 9, in the area light source module 10, the incident side surface includes a first incident side surface 1311 and a second incident side surface 1312 which are adjacent to each other, the first incident side surface 1311 is provided with a first light source 210 and a first light valve component 301, and the second incident side surface 1312 is provided with a second light source 220 and a second light valve component 302. In this way, a plurality of first zones 141 corresponding to the first light source 210 and a plurality of second zones 142 corresponding to the second light source 220 may be formed in the light guide plate 100. The plurality of first zones 141 and the plurality of second zones 142 cross each other, so that the light distribution in the light guide plate 100 includes the light of the first zones 141 and the light of the second zones 142, and therefore, the adjustable light-emitting region of the light-emitting surface is composed of the overlapping portions of the first zones 141 and the second zones 142, that is, the adjustable light-emitting region of the light-emitting surface of the light guide plate may be in an array distribution, which can further improve the accuracy of the dynamic contrast of the area light source module.

FIG. 10 is a schematic diagram of the working principle of the area light source module illustrated in FIG. 9.

For example, in at least an embodiment of the present disclosure, as illustrated in FIG. 9 and FIG. 10, by adjusting the first light valve component 301, the brightness of the regions 141a, 141b, and 141c in the plurality of first zones 141 can be the maximum, and the brightness of other first zones 141 can be the minimum. By adjusting the second light valve component 302, the brightness of the regions 142a, 142b, and 142c in the plurality of second zones 142 can be the maximum, and the brightness of other second zones 142 can be the minimum. In this way, in the light-emitting surface of the light guide plate 100, the brightness of the region A is the maximum, and the brightness of the other regions of the light-emitting surface is the minimum. Similarly, by adjusting the light valve component, the brightness of the region A can also be the minimum, and the brightness of the other regions of the light-emitting surface can be the maximum.

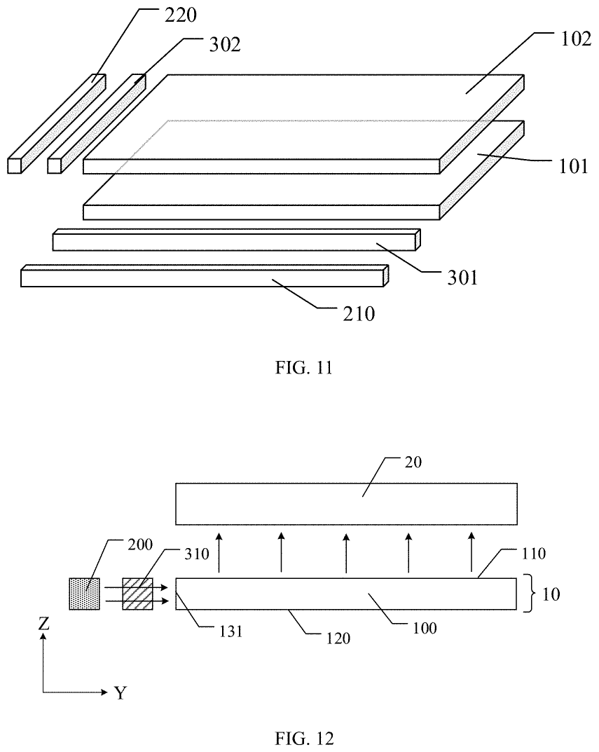

FIG. 11 is a planar diagram of further still another area light source module provided by an embodiment of the present disclosure.

For example, in the area light source module provided by at least an embodiment of the present disclosure, the light guide plate includes a first sub light guide plate and a second sub light guide plate which are stacked with each other, the first light source and the first light valve component correspond to the first sub light guide plate, and the second light source and the second light valve component correspond to the second sub light guide plate. For example, as illustrated in FIG. 10, the light guide plate includes a first sub light guide plate 101 and a second sub light guide plate 102 which are stacked with each other, the first sub light guide plate 101 is closer to the light-emitting side, and the second sub light guide plate 102 is farther away from the light-emitting side. A side of the first sub light guide plate 101 is provided with the first light source 210 and the first light valve component 301, a side of the second sub light guide plate 102 is provided with the second light source 220 and the second light valve component 302, and the surface, away from the first sub light guide plate 101, of the second sub light guide plate 102 is the light-emitting surface of the light guide plate. The light emitted by the first light source 210 enters the first sub light guide plate 101, and then the light emitted out from the first sub light guide plate 101 enters the second sub light guide plate 102, so that the light emitted by the second sub light guide plate 102 is composed of the light emitted out from the first sub light guide plate 101 and the light emitted from the first light source into the second sub light guide plate 102. The principle of the above-mentioned area light source module to implement the dynamic contrast can be with reference to the related descriptions in the embodiments illustrated in FIG. 9 and FIG. 10, and details are not described herein.

For example, in at least an embodiment of the present disclosure, in the case where the light guide plate in the area light source module includes the first sub light guide plate and the second sub light guide plate which are stacked with each other, both adjacent side surfaces of the first sub light guide plate and/or the second sub light guide plate are provided with one light source and one light valve component. In this way, the accuracy of the dynamic contrast of the area light source module can be further improved. In the above area light source module, the arrangement of the sub light guide plate (for example, the first sub light guide plate and the second sub light guide plate), the light source, and the light valve component of each layer can be with reference to the structure illustrated in FIG. 9.

It should be noted that, in at least an embodiment of the present disclosure, the light guide plate may also be configured to be formed by stacking three or more sub light guide plates, and both adjacent side surfaces of each sub light guide plate are provided with one light source and one light valve component.

For example, in at least an embodiment of the present disclosure, other optical structures may also be provided in the area light source module. For example, a reflective layer or a film layer with a refractive index smaller than that of the light guide plate is provided on one side of the second main surface of the light guide plate, which improves the light utilization rate. For example, a net dot can be provided on the light guide plate, or a light guide structure can be provided on the light-emitting surface of the light guide plate, so as to guide the light in the light guide plate. For example, an optical film such as a prism film may be provided on one side of the light-emitting surface of the light guide plate to improve the collimation degree of the light emitted by the area light source module.

FIG. 12 is a cross-sectional diagram of a display device provided by an embodiment of the present disclosure.

At least an embodiment of the present disclosure further provides a display device including the area light source module in any one of the above embodiments. For example, as illustrated in FIG. 12, the display device includes an area light source module 10 and a display panel 20 on a light-emitting side of the area light source module 10. The area light source module 10 serves as a backlight source, and the display panel 20 corresponds to the light-emitting surface 110 of the light guide plate 100 and uses the light provided by the area light source module 10 for display. The structure of the area light source module can be with reference to the related descriptions in the above embodiments, and details are not described herein.

In the display device provided by at least an embodiment of the present disclosure, the display panel may be a liquid crystal display panel, the liquid crystal display panel includes an array substrate and an opposite substrate which are opposite to each other to form a liquid crystal cell, and the liquid crystal cell is filled with a liquid crystal material. For example, the opposite substrate is a color filter substrate. The pixel electrode of each pixel unit of the array substrate is used to apply an electric field to control the orientation degree of the liquid crystal material, so as to perform a display operation.

In the display device provided by at least an embodiment of the present disclosure, the display panel may be an electronic paper display panel, an electronic ink layer is provided on the substrate in the display panel, and the pixel electrode of each pixel unit is configured to apply a voltage for driving charged micro-particles in the electronic ink layer to move, so as to perform a display operation.

For example, in the display device provided by at least an embodiment of the present disclosure, the display panel may be configured as a transmissive display panel, and the area light source module may be located on the backlight side of the display panel to serve as a backlight module.

In at least an embodiment of the present disclosure, the type of display device is not limited. For example, the display device may be any product or component with a display function, such as a tablet computer, a television, a display, a notebook computer, a digital photo frame, a navigator, etc.

At least an embodiment of the present disclosure further provides a control method of the above area light source module, and the control method includes: controlling the light valve component to control the passing rate of the light emitted from the light source into the light guide plate through the incident side surface. The structure of the area light source module can be with reference to the related descriptions in the above embodiments, and details are not described herein. In the above control method, the light valve component is used to control the passing rate of the light emitted from the light source into the light guide plate, so that the distribution of light in the light guide plate can be adjusted, thereby adjusting the distribution of light emitted by the area light source module and improving the dynamic contrast of the area light source module.

For example, in the control method provided by at least an embodiment of the present disclosure, the light valve component includes a plurality of light valve units side by side, and the control method further includes: controlling light transmittances of at least two adjacent light valve units, so as to adjust an intensity of incident light on a region, corresponding to the at least two adjacent light valve units, of the incident side surface of the light guide plate. In this way, the distribution of light in the region, corresponding to the light valve unit, of the light guide plate can be controlled to allow the intensities of light emitted from different light-emitting regions of the light guide plate to be different, thereby controlling the gray level of the light-emitting region of the light guide plate and improving the dynamic contrast of the area light source module.

At least an embodiment of the present disclosure provides an area light source module and a control method thereof, and a display device, which have at least one of the following beneficial effects.

(1) In the area light source module provided by at least an embodiment of the present disclosure, the light source is located on the side surface of the light guide plate, which can reduce the design thickness of the area light source module and facilitate the light and thin design.

(2) In the area light source module provided by at least an embodiment of the present disclosure, the light valve component controls the passing rate of the light emitted from the light source into the light guide plate, so that the distribution of light in the light guide plate can be adjusted, thereby adjusting the distribution of light emitted by the area light source module and improving the dynamic contrast of the area light source module.

(3) In the area light source module provided by at least an embodiment of the present disclosure, the number of light sources provided in the area light source module is smaller, which can reduce the cost of the area light source module and avoid poor heat dissipation of the area light source module.

(4) In the area light source module provided by at least an embodiment of the present disclosure, two adjacent side surfaces of the light guide plate are respectively provided with one light source and one light valve component, so that the adjustable light-emitting region of the light-emitting surface of the light guide plate can be in an array distribution, thereby further improving the accuracy of the dynamic contrast of the area light source module.

The following statements should be noted.

(1) The accompanying drawings involve only the structure(s) in connection with the embodiment(s) of the present disclosure, and other structure(s) can be referred to common design(s).

(2) For the purpose of clarity, in accompanying drawings for illustrating the embodiment(s) of the present disclosure, the thickness of a layer or a region may be enlarged or narrowed, that is, the drawings are not drawn in a real scale.

(3) In case of no conflict, features in one embodiment or in different embodiments can be combined to obtain new embodiments.

What have been described above are only specific implementations of the present disclosure, the protection scope of the present disclosure is not limited thereto, and the protection scope of the present disclosure should be based on the protection scope of the claims.

1. An area light source module, comprising:
a light guide plate, comprising two main surfaces and a side surface between the two main surfaces, wherein the side surface comprises an incident side surface;
a light source opposite to the incident side surface; and
a light valve component between the light guide plate and the light source,
wherein the light valve component is configured to control a passing rate of light emitted from the light source into the light guide plate through the incident side surface.

2. The area light source module according to claim 1, wherein the light valve component comprises a plurality of light valve units arranged side by side, and a light transmittance of each of the light valve units is adjustable.

3. The area light source module according to claim 2, wherein the plurality of light valve units are arranged in a row or in an array of a plurality of rows and a plurality of columns along the incident side surface.

4. The area light source module according to claim 2, wherein each of the light valve units comprises an electronic ink light valve unit, the electronic ink light valve unit comprises an electronic ink layer and a plurality of control electrodes, and the electronic ink layer comprises charged light-shielding particles, and
the plurality of control electrodes are configured to control distribution of the charged light-shielding particles in the electronic ink layer to adjust a light transmittance of the electronic ink light valve unit.

5. The area light source module according to claim 4, wherein the electronic ink layer comprises a plurality of capsules side by side, the capsules are filled with electrophoretic liquids and the charged light-shielding particles, and the charged light-shielding particles are suspended in the electrophoretic liquids.

6. The area light source module according to claim 4, wherein the plurality of control electrodes comprise:
a first electrode and a second electrode, which are opposite to each other and respectively arranged on two main surfaces of the electronic ink layer along a direction from the light source to the light guide plate; and
a third electrode and a fourth electrode, which are opposite to each other and respectively arranged on two side surfaces of the electronic ink layer along a direction perpendicular to the direction from the light source to the light guide plate.

7. The area light source module according to claim 2, wherein each of the light valve units comprises an electrochromic light valve unit,
the electrochromic light valve unit comprises an electrochromic layer and a control electrode, and
the control electrode is configured to be applied with a voltage to adjust a light transmittance of the electrochromic layer.

8. The area light source module according to claim 2, wherein each of the light valve units comprises a liquid crystal light valve unit, and the liquid crystal light valve unit comprises:
a liquid crystal layer, and
a control electrode configured to control orientation of liquid crystal molecules in the liquid crystal layer to adjust a light transmittance of the liquid crystal light valve unit.

9. The area light source module according to claim 8, wherein the liquid crystal light valve unit further comprises two polarizers,
the two polarizers are respectively on both sides of the liquid crystal layer along a direction from the light source to the light guide plate, and
polarization directions of the two polarizers are perpendicular to each other.

10. The area light source module according to claim 2, further comprising a controller, wherein the controller is coupled to the light valve unit to control the light valve unit.

11. The area light source module according to claim 1, wherein the light source comprises a strip-shaped light source, or the light source comprises a plurality of light-emitting units arranged at intervals.

12. The area light source module according to claim 2, wherein the light guide plate comprises a plurality of strip-shaped zones spliced with each other in parallel, and the incident side surface is formed by splicing end surfaces of the plurality of strip-shaped zones.

13. The area light source module according to claim 12, wherein each of the strip-shaped zones corresponds to at least one of the light valve units.

14. The area light source module according to claim 12, wherein the incident side surface comprises a first incident side surface and a second incident side surface which are adjacent to each other, the light source comprises a first light source and a second light source, and the light valve component comprises a first light valve component and a second light valve component; and
the first light source and the first light valve component are on the first incident side surface, and the second light source and the second light valve component are on the second incident side surface.

15. The area light source module according to claim 14, wherein the light guide plate comprises a first sub light guide plate and a second sub light guide plate which are stacked with each other; and
the first light source and the first light valve component correspond to the first sub light guide plate, and the second light source and the second light valve component correspond to the second sub light guide plate.

16. The area light source module according to claim 1, wherein an orthographic projection of the light source on the incident side surface coincides with an orthographic projection of the light valve component on the incident side surface, or
the orthographic projection of the light source on the incident side surface is within the orthographic projection of the light valve component on the incident side surface.

17. The area light source module according to claim 1, wherein the light valve component is in direct contact with the incident side surface.

18. A display device, comprising the area light source module according to claim 1.

19. A control method of the area light source module according to claim 1, comprising:
controlling the light valve component, so as to control the passing rate of the light emitted from the light source into the light guide plate through the incident side surface.

20. The control method according to claim 19, wherein the light valve component comprises a plurality of light valve units arranged side by side, and the control method further comprises:
controlling light transmittances of at least two adjacent light valve units, so as to adjust an intensity of incident light on a region, corresponding to the at least two adjacent light valve units, of the incident side surface of the light guide plate.
